(19) United States
(12) Patent Application Publication
(10) Pub. No.: US 2013/0149144 A1
(43) Pub. Date: Jun. 13, 2013

(54) WINDMILL

(71) Applicant: JAMES LAU, Tustin, CA (US)

(72) Inventor: JAMES LAU, Tustin, CA (US)

(21) Appl. No.: 13/323,661

(22) Filed: Dec. 12, 2011

(51) Int. Cl. F03D 3/06; F03D 11/04

(52) U.S. Cl. 416/1; 416/244 R; 416/243

(57) ABSTRACT

A windmill structure for converting wind energy to electrical energy comprises a thrust holding foundation having a plurality of holes for fixing the windmill structure on a ground surface. A tower consists of a bottom end and a top end. The bottom end of the tower is positioned at a middle portion of the foundation. A plurality of wind-engaging blades extended from the top end of the tower. A plurality of concave panels with larger surface area may be used as the plurality of wind-engaging blades. A plurality of supporting structures is utilized for attaching the plurality of wind-engaging blades on the top end of the tower and a power generator molded at one end of the tower. The arrangement of the plurality of wind-engaging blades facilitates to attain maximum rotation with minimal wind energy thereby increasing the overall efficiency of the windmill structure.

### BACKGROUND OF THE INVENTION

1. Technical Field of the Invention

The present invention relates in general to windmill structures. More specifically, the present invention relates to a windmill for converting wind energy to other forms of energy employing a power generator.

2. Description of the Related Art

A windmill is a machine that converts wind energy into usable energy through the rotation of adjustable wind-engaging blades. Conventionally, the energy generated by a windmill has been used to grind food grains and for pumping water. There are two classes of windmill, horizontal axis windmill and vertical axis windmill. Horizontal axis windmills are more efficient.

Over the past decades, vertical axis windmills are commonly used. Its inefficiency of operation led to the evolution of the legion horizontal axis designs. There are a variety of vertical windmills such as tower mill, fan mill, post mill, and the smock mill. The earliest design is the post mill. This design gives flexibility to the mill operator because the windmill can catch the maximum wind depending on the direction of the wind.

Wind energy is a renewable kind of energy and it is a powerful source as well. The amount of electricity produced depends upon the size of the windmill. The shaft can drive stronger if the structure of the windmill is bigger, and thus the electricity produced will be greater. The wind catching by the windmill depends upon the wind-engaging blades. The shape of the wind-engaging blade is a main component which can boost the wind catching. When the wind flows over the blades, these blades collect kinetic energy. Then the blades, which are connected onto a shaft, revolve slowly and produce the rotating force into the gearbox. The gearbox then modifies this rotating force. At that moment, the generator, which is connected to the gearbox, creates electricity.

Currently straight panels are used as the wind-engaging blades. While using straight panels there is a chance of higher drag. Drag co-efficient is a factor which affects wind catching. Wind catching is higher where there is less drag. Straight panels have greater drag when compared to other types of panels. So the present inventions have limitations. Also, the present inventions need large vertical and horizontal space. As a result manufacturing cost is also high while the overall efficiency is less.

Hence, it can be seen, that there is a need to find an optimum blade shape that will increase the overall electrical generation productivity of a windmill. Such a needed device would achieve the maximum rotation with minimal wind speed. Further, the needed device could be produced with minimal manufacturing cost. The needed device would have larger surface area on blades so it could achieve maximum rotation with minimal wind speed.

### SUMMARY OF THE INVENTION

To minimize the limitations found in the prior art, and to minimize other limitations that will be apparent upon the reading of the specifications, the present invention is a windmill structure for converting wind energy to electrical energy. The windmill structure consists of a thrust holding foundation having a plurality of holes for fixing the windmill structure on a ground surface. A tower having a bottom end and a top end where the bottom end being positioned at a middle portion of the foundation and a plurality of wind-engaging blades extended from the top end of the tower. The plurality of wind-engaging blades is arranged in a plurality of levels. The windmill structure has minimum three levels of the plurality of wind-engaging blades. A plurality of concave panels with larger surface area may be used as the plurality of wind-engaging blades. The shape and size of the plurality of wind-engaging blades affects the speed of rotation of the plurality of wind-engaging blades. The employment of the plurality of concave panels facilitates to minimize the drag co-efficient. Drag co-efficient is a main factor which affects the amount of wind catching. The surface where there is less drag will have greater wind catching. The plurality of concave panels has less drag co-efficient when compared to straight panels. A plurality of supporting structures is provided for attaching the plurality of wind-engaging blades on the top end of the tower and a power generator molded at the top, middle, or bottom end of the tower. The arrangement of the plurality of wind-engaging blades facilitates to attain maximum rotation with minimal wind energy thereby increasing the overall efficiency of the windmill structure. The height of the tower affects the productivity of the windmill structure. The windmill structure with higher height is more productive. It will be due to the fact that the wind speed increases with the height of the tower.

The plurality of wind-engaging blades arranged in the plurality of levels is according to a formula: the angle between wind-engaging blades on each level=360 degrees/the number of wind-engaging blades on each level. The plurality of wind-engaging blades attached to the top end of the tower utilizes the plurality of supporting structures. The plurality of supporting structures may be a lattice type or a network arrangement. The plurality of supporting structures contributes the facility to rotate freely around the axis of the windmill structure. The plurality of wind-engaging blades has an outer curve and an inner curve. The inner curve, arranged in a concave manner, may be the catching surface. The plurality of concave panels is capable to catch the wind from any direction. The arrangement of the plurality of concave panels enables to reinforce the adjacent panel and thereby increases the speed of the rotation of the plurality of wind-engaging blades. The plurality of concave panels facilitates to catch the wind energy from any direction and is capable to channel the wind energy to the adjacent concave panel. The plurality of concave panels is positioned at a different angle to attain maximum rotation. The angle between the first concave panel in the first level and the first panel in the last level is according to a formula based on the optimal catch angle which ranges from 150 to 210 degrees. The first concave panel in the first level will be placed at 0 degrees. The offset for placement of the first concave panel in the second level will be calculated as follows: optimal catch angle/(the number of levels minus 1). The arrangement facilitates to catch maximum wind energy from any direction. The plurality of wind-engaging blades with larger surface area helps to rotate with minimal wind energy.

One objective of the invention is to provide a windmill structure for converting wind energy to electrical energy with low manufacturing cost.

Another objective of the invention is to provide a plurality of wind-engaging blades with larger surface area to attain maximum rotation with minimal wind energy.

A third objective of the invention is to provide a windmill structure with unique arrangements of a plurality of concave panels as a plurality of wind-engaging blades.

Another objective of the invention is to provide a plurality of wind engaging blades arranged in a plurality of levels to catch optimal wind energy from any direction.

Yet another objective of the invention is to provide a windmill structure with easy manufacturing and better efficiency.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention, illustrating a windmill structure;

FIG. 2 is a perspective view of the present invention, illustrating an arrangement of a plurality of wind-engaging blades;

FIG. 3 is a top view of the present invention shown in FIG. 1, illustrating a power generator molded at a top end of the windmill structure; and

FIG. 4 is a front perspective view of another embodiment of the present invention, illustrating a windmill structure with a power generator molded at the bottom end of the windmill structure.

### DETAILED DESCRIPTION OF THE DRAWINGS

In the following discussion that addresses a number of embodiments and applications of the present invention, reference is made to the accompanying drawings that form a part of hereof, and in which is shown by way of illustration specific embodiments in which the invention may be practiced. It is to be understood that other embodiments may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

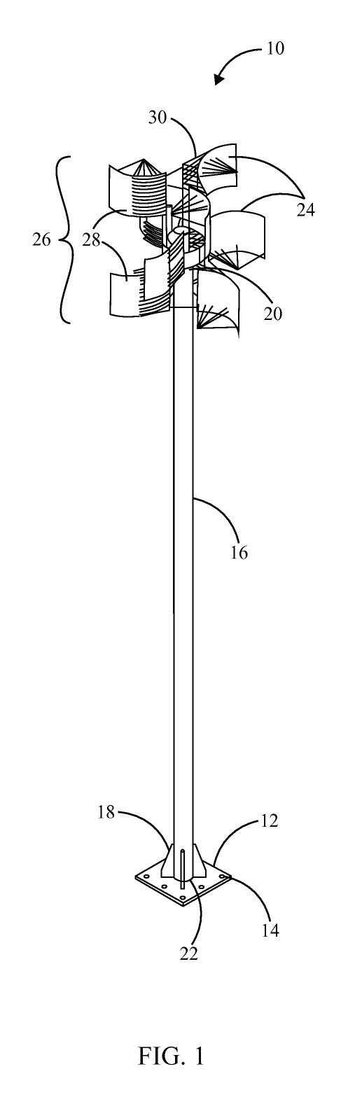

FIG. 1 is a perspective view of the windmill structure 10 for converting wind energy to electrical energy. The windmill structure 10 comprises a thrust holding foundation 12 having a plurality of holes 14 for fixing the windmill structure 10 on a ground surface (not shown). A tower 16 having a bottom end 18 and a top end 20 where the bottom end 18 is being positioned at a middle portion 22 of the foundation 12. A plurality of wind-engaging blades 24 is extended from the top end 20 of the tower 16. The plurality of wind-engaging blades 24 are arranged in a plurality of levels 26. The windmill structure 10 may have minimum three levels of the plurality of wind-engaging blades 24. A plurality of concave panels 28 with larger surface area may be used as the plurality of wind-engaging blades 24. The shape and size of the plurality of wind-engaging blades 24 affects the speed of rotation. The employment of the plurality of concave panels 28 facilitates to minimize the drag coefficient. Drag co-efficient is a main factor which affects the amount of wind catching. The surface where there is less drag will have greater wind catching. The plurality of concave panels 28 has less drag co-efficient when compared to straight panels (not shown). A plurality of supporting structures 30 is utilized for attaching the plurality of wind-engaging blades 24 to the top end 20 of the tower 16 and a power generator (not shown) molded at the top end 20 of the tower 16. The arrangement of the plurality of wind-engaging blades 24 facilitates to attain maximum rotation with minimal wind energy thereby increasing the overall efficiency of the windmill structure 10. The height of the tower 16 affects the productivity of the windmill structure 10. The windmill structure 10 with higher height is more productive. It will be due to the fact that the amount of wind catching increases with the height of the tower 16.

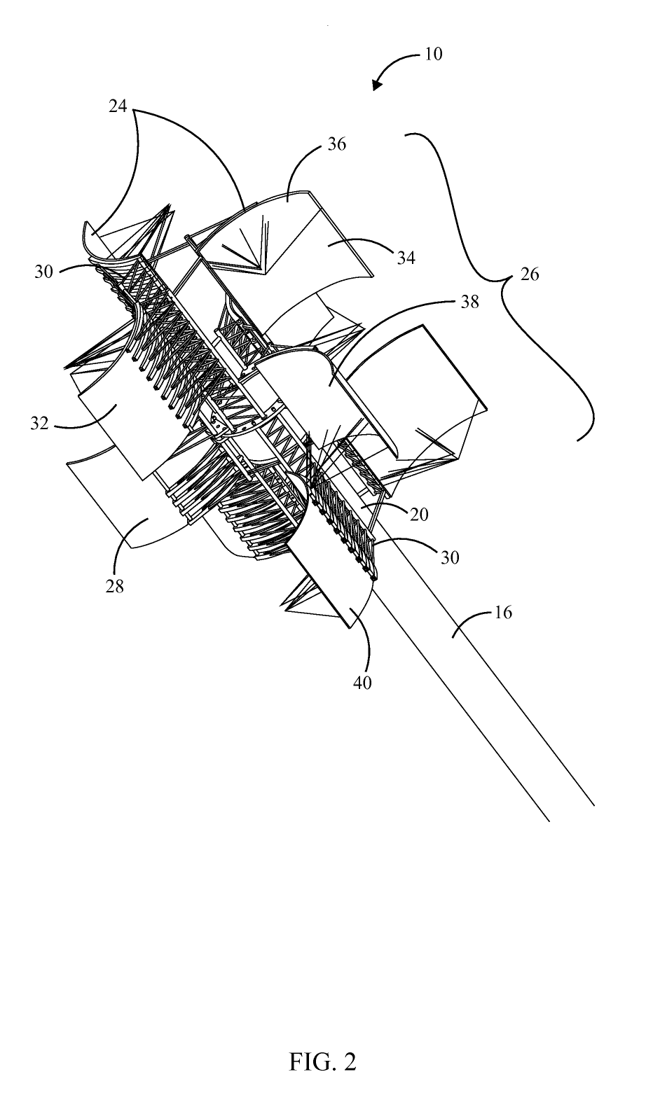

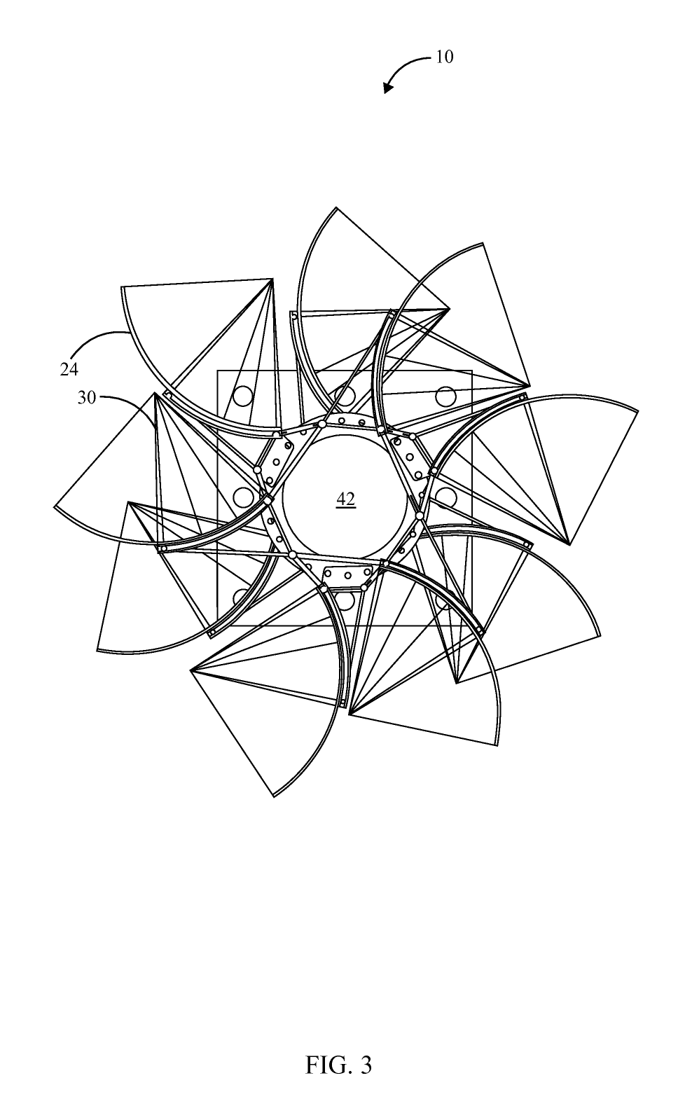

FIG. 2 shows an arrangement of the plurality of wind-engaging blades 24 employed to catch maximum wind energy by minimizing the drag co-efficient. The plurality of concave panels 28 may be used as the wind-engaging blades 24. The plurality of wind-engaging blades 24 arranged in the plurality of level 26 is according to a formula: the angle between wind-engaging blades on each level=360 degrees/the number of wind-engaging blades on each level. The plurality of wind-engaging blades 24 attached to the top end 20 of the tower 16 utilizes the plurality of supporting structures 30. The plurality of supporting structures 30 may be a lattice type or a network arrangement. The plurality of supporting structures 30 contributes the facility to the plurality of wind-engaging blades to rotate freely. The plurality of wind-engaging blades 24 has an outer curve 32 and an inner curve 34. The inner curve 34, arranged in a concave manner, may be the catching surface. The plurality of concave panels 28 is capable to catch the wind from any direction. The arrangement of the plurality of concave panels 28 enables to reinforce the adjacent panel and thereby increases the speed of the rotation of the plurality of wind-engaging blades 24. The plurality of concave panels 28 facilitates to catch the wind energy from any direction and is capable to channel the wind energy to the adjacent concave panel. The plurality of concave panels 28 is positioned at a different angle to attain maximum rotation. The angle between a first concave panel in the first level 36 and a first concave panel in the second level 38 will be 95 degree offset. The angle between the first concave panel in the first level 36 and a first concave panel in the third level 40 will be 190 degree offset. The arrangement facilitates to catch the maximum wind energy from any direction. The plurality of wind-engaging blades 24 with larger surface area helps to rotate with minimal wind energy. FIG. 3 shows the power generator 42 mounted on the top end 20 of the tower 16 employed to convert the wind energy to electrical energy. The power generator 42 may be incorporated at the top end 20 or at the bottom end 18 of the tower 16. The type of the power generator 42 is important because the energy efficiency of a generator may vary among different brands.

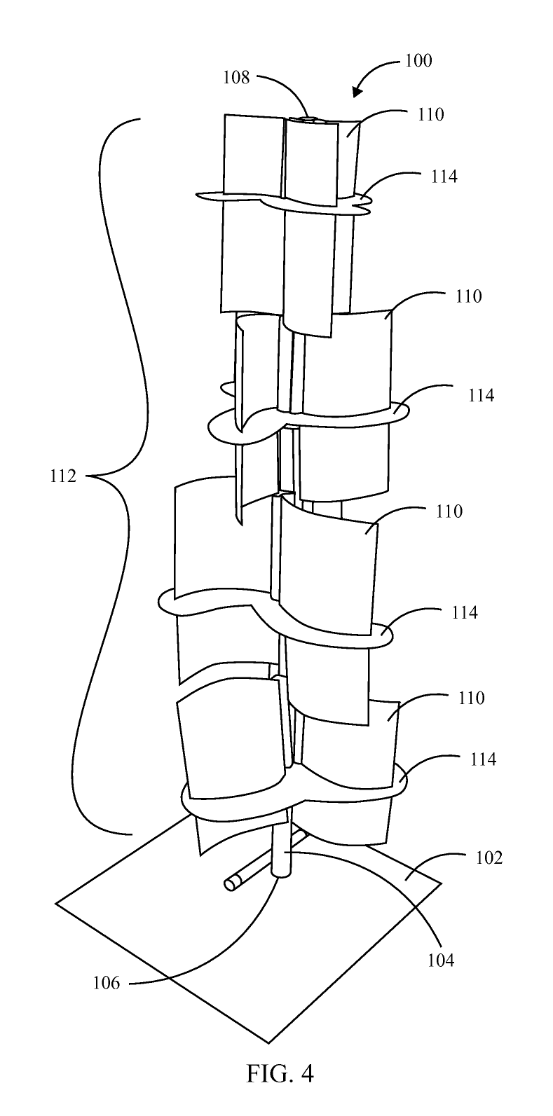

FIG. 4 is a front perspective view of another embodiment of the windmill structure 100 for converting wind energy to electrical energy. The windmill structure 100 according to the embodiment of the present invention comprises a foundation 102 for fixing the windmill structure 100 on a ground surface. A pole (not shown) within a cylindrical structure 104 having a bottom end 106 and a top end 108 where the bottom end 106 is being positioned on the foundation 102. A plurality of concave panels 110 with larger surface area is extended from the top end 108 of the cylindrical structure 104. The plurality of concave panels 110 are arranged in a plurality of levels 112. Each of the plurality of concave panels 110 are placed at 120 degrees apart. The windmill structure 100 may have minimum three levels of the plurality of concave panels 110. A plurality of supporting structures 114 is utilized for attaching the plurality of concave panels 110 to the cylindrical structure 104 and a power generator (not shown) molded at the bottom end 106 of the cylindrical structure 104. The arrangement of the plurality of concave panels 110 facilitates to attain maximum rotation with minimal wind energy thereby increasing the overall efficiency of the windmill structure 100. The curvature of the plurality of concave panels 110 should fall within 65 to 90 degrees to achieve the best rotation surface for optimal performance.

The foregoing description of the preferred embodiment of the present invention has been presented for the purpose of illustration and description. It is not intended to be exhaustive or to limit the invention to the precise form disclosed. For example, the windmill structure 10 may have maximum any number of levels of wind-engaging blades and in each level may have maximum any number of wind-engaging blades. Many modifications and variations are possible in light of the above teachings. It is intended that the scope of the present invention not be limited by this detailed description, but by the claims and the equivalents to the claims appended hereto.

What is claimed is:

1. A windmill structure comprising:
a thrust holding foundation having a plurality of holes;
a tower having a bottom end and a top end, the bottom end being positioned at a middle portion of the foundation;
a plurality of wind-engaging blades extended from the top end of the tower;
a plurality of supporting structures for attaching the plurality of wind-engaging blades to the top end of the tower; and
a power generator molded at one end of the tower;
whereby the arrangement of the plurality of wind-engaging blades facilitates to attain maximum rotation with minimal wind energy thereby increasing the overall efficiency.

2. The windmill structure of claim 1 wherein the plurality of wind-engaging blades may be a plurality of concave panels having larger surface area.

3. The windmill structure of claim 2 wherein the plurality of concave panels facilitates to catch maximum amount of wind energy by minimizing drag co-efficient.

4. The windmill structure of claim 1 wherein the plurality of wind-engaging blades arranged in a plurality of levels.

5. The windmill structure of claim 1 wherein the power generator is employed to convert the wind energy to electrical energy.

6. The windmill structure of claim 1 wherein the wind-engaging blades can be attached to the top end of the tower employing the plurality of support structures.

7. The windmill structure of claim 6 wherein the plurality of support structures may be a lattice type.

8. The windmill structure of claim 6 wherein the plurality of support structures may be a network arrangement.

9. The windmill structure of claim 1 wherein the plurality of wind-engaging blades may have an inner curve.

10. The windmill structure of claim 1 wherein the plurality of wind-engaging blades includes an outer curve.

11. The windmill structure of claim 1 wherein the inner curve of the plurality of wind-engaging blades functions as the catching surface.

12. The windmill structure of claim 1 wherein the angle arrangement of the wind-engaging blades on each level follows a formula:
the angle between the wind-engaging blades on each level=360 degrees/the number of wind-engaging blades on each level

13. The windmill structure of claim 1 wherein the angle arrangement between the first concave panel on the first level and the first panel on the last level is based on optimal catch angle and follows a formula:
the angle between the first concave panel on the first level and the first concave panel on the last level=optimal catch angle/(the number of levels minus one)

14. The windmill structure of claim 13 wherein the preferred range for optimal catch angle may fall within 150-210 degrees.

15. The windmill structure of claim 1 wherein the plurality of holes in the foundation can be utilized for fixing the windmill structure on a ground surface.

16. A method for rotating a plurality of concave panels disposed on a windmill structure with minimal wind energy, the method comprising the steps of:
a) catching the wind energy by one of the plurality of concave panel;
b) channeling the wind energy to an adjacent concave panel;
c) rotating the plurality of concave panels; and
d) converting the wind energy to an electrical energy.

17. The method of claim 16 wherein the plurality of concave panels is capable to catch the wind from any direction.

18. The method of claim 16 wherein the plurality of concave panels rotate in the direction of the wind.

19. The method of claim 16 wherein the plurality of concave panels reinforces the adjacent concave panel.

20. The method of claim 16 wherein the conversion of wind energy to an electrical energy employing a power generator.

21. The method of claim 16 wherein the plurality of concave panels includes an inner curve.

22. The method of claim 21 wherein the inner curve of the plurality of concave panels may be the catching surface.

23. The method of claim 16 wherein the plurality of concave panels includes an outer curve.
